(19) United States
(12) Patent Application Publication
(10) Pub. No.: US 2010/0039889 A1
(43) Pub. Date: Feb. 18, 2010

(54) MOUNTING A SEISMIC SENSOR IN A CABLE

(76) Inventors: Oeyvind Teigen, Oslo (NO); James Martin, Cambridge (GB); Erik Rhein-Knudsen, La Baule (FR)

Correspondence Address: WesternGeco L.L.C.;Kevin McEnaney, 10001 Richmond Avenue, HOUSTON, TX, 77042-4299, US

(21) Appl. No.: 12/193,035

(22) Filed: Aug. 17, 2008

(51) Int. Cl. G01V 1/38

(52) U.S. Cl. 367/20

(57) ABSTRACT

An apparatus includes a cable; and a gel-based filler material, seismic sensors that are disposed in the cable. The seismic sensors are suspended in pockets, and each pocket contains a material that has a shear stiffness that is less than a shear stiffness of the gel-based filler material to attenuate a flow noise.

### BACKGROUND

The invention generally relates to mounting a seismic sensor in a cable, such as a streamer, for example.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, an apparatus includes a cable; and a gel-based filler material, seismic sensors that are disposed in the cable. The seismic sensors are suspended in pockets, and each pocket contains material that has a shear stiffness that is less than a shear stiffness of the gel-based filler material for purposes of attenuating a flow noise.

In another embodiment of the invention, an apparatus includes a cable that contains a gel-based filler material; and a spacer, an enclosure and a seismic sensor that are disposed in the cable. The enclosure contains a second material that has a shear stiffness that is less than a shear stiffness of the gel-based filler material; and the enclosure at least partially extends into a passageway of the spacer. The seismic sensor is suspended in the second material in the enclosure.

In another embodiment of the invention, an apparatus includes an outer cable covering, a spacer, a gel and a seismic sensor. The outer cable covering defines an interior space, and the spacer is located in the interior space to support the outer cable covering. The spacer includes a passageway, and the gel is located in the passageway. The seismic sensor is suspended in the gel in the passageway.

In another embodiment of the invention, a technique includes providing a cable that has a spacer and a seismic sensor. The technique includes suspending the seismic sensor in a gel in a passageway of the spacer.

In yet another embodiment of the invention, a technique includes providing a cable that contains seismic sensors and a gel-based filler material. The technique includes attenuating a flow noise, including suspending the seismic sensors in pockets that contain materials that each have a shear stiffness that is less than a shear stiffness of the gel-based filler material.

Advantages and other features of the invention will become apparent from the following drawing, description and claims.

### BRIEF DESCRIPTION OF THE DRAWING

FIG. 1 is a schematic diagram of a marine seismic data acquisition system according to an embodiment of the invention.

FIG. 2 is a cross-sectional view of a streamer taken along line 2-2 of FIG. 1 according to an embodiment of the invention.

FIG. 3 is a flow diagram depicting a technique to reduce flow noise in a gel-filled streamer according to an embodiment of the invention.

FIGS. 4 and 5 are cross-sectional views of streamers according to embodiments of the invention.

### DETAILED DESCRIPTION

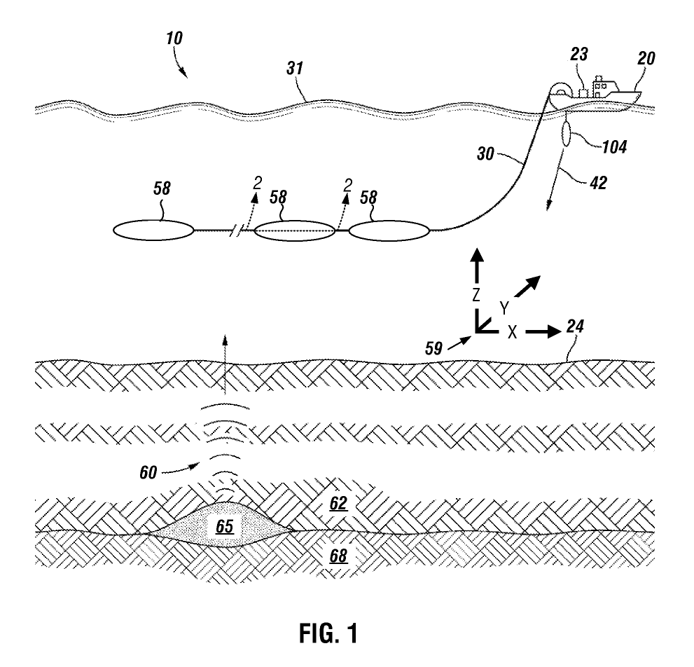

FIG. 1 depicts an embodiment 10 of a marine seismic data acquisition system in accordance with some embodiments of the invention. In the system 10, a survey vessel 20 tows one or more seismic streamers 30 (one exemplary streamer 30 being depicted in FIG. 1) behind the vessel 20. The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors 58 that record seismic signals.

In accordance with embodiments of the invention, the seismic sensors 58 may be pressure sensors only or may be multi-component seismic sensors. For the case of multi-component seismic sensors, each sensor is capable of detecting a pressure wavefield and at least one component of a particle motion that is associated with acoustic signals that are proximate to the multi-component seismic sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the multi-component seismic sensor may include one or more hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the seismic sensor. It is noted that the multi-component seismic sensor may be implemented as a single device or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system 10 includes a seismic source 104 that may be formed from one or more seismic source elements, such as air guns, for example, which are connected to the survey vessel 20. Alternatively, in other embodiments of the invention, the seismic source 104 may operate independently of the survey vessel 20, in that the seismic source 104 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic source 104 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are acquired by the sources 40 produce corresponding reflected acoustic signals, or pressure waves 60, which are sensed by the seismic sensors 58. It is noted that the pressure waves that are received and sensed by the seismic sensors 58 include “up going” pressure waves that propagate to the sensors 58 without reflection, as well as “down going” pressure waves that are produced by reflections of the pressure waves 60 from an air-water boundary 31.

The seismic sensors 58 generate signals (digital signals, for example), called “traces,” which indicate the acquired measurements of the pressure wavefield and particle motion (if the sensors are particle motion sensors). The traces are recorded and may be at least partially processed by a signal processing unit 23 that is deployed on the survey vessel 20, in accordance with some embodiments of the invention. For example, a particular multi-component seismic sensor may provide a trace, which corresponds to a measure of a pressure wavefield by its hydrophone; and the sensor may provide one or more traces that correspond to one or more components of particle motion, which are measured by its accelerometers.

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23.

The main mechanical parts of a conventional streamer typically include skin (the outer covering); one or more stress members; seismic sensors; spacers to support the skin and protect the seismic sensors; and a filler material. In general, the filler material typically has a density to make the overall streamer neutrally buoyant; and the filler material typically has properties that make the material acoustically transparent and electrically non conductive.

Certain fluids (kerosene, for example) possess these properties and thus, may be used as streamer filler materials. However, a fluid does not possess the ability to dampen vibration, i.e., waves that propagate in the inline direction along the streamer. Therefore, measures typically are undertaken to compensate for the fluid's inability to dampen vibration. For example, the spacers may be placed either symmetrically around each seismic sensor (i.e., one spacer on each side of the sensor); or two sensors may be placed symmetrically about each spacer. The vibration is cancelled by using two spacers symmetrically disposed about the seismic sensor because each spacer sets up a pressure wave (as a result of inline vibration), and the two waves have opposite polarities, which cancel each other. Two seismic sensors may be disposed symmetrically around one spacer to achieve a similar cancellation effect, but this approach uses twice as many sensors. Furthermore, the latter approach may degrade performance due to nonsymmetrical positioning of the other seismic sensors.

When gel is used as the filler material, the noise picture changes, as flow noise (instead of vibration) becomes the dominant noise source. More specifically, the main mechanical difference between fluid and gel as a filler material is the shear stiffness. A fluid has zero shear stiffness, and shear stresses from viscous effects typically are negligible. The shear stiffness is what makes a gel possess solid-like properties. It has been discovered through modeling that the shear stiffness in gel degrades the averaging of flow noise. The degradation in the flow noise cancellation may be attributable to relatively little amount of gel being effectively available to communicate the pressure between each side of the spacer.

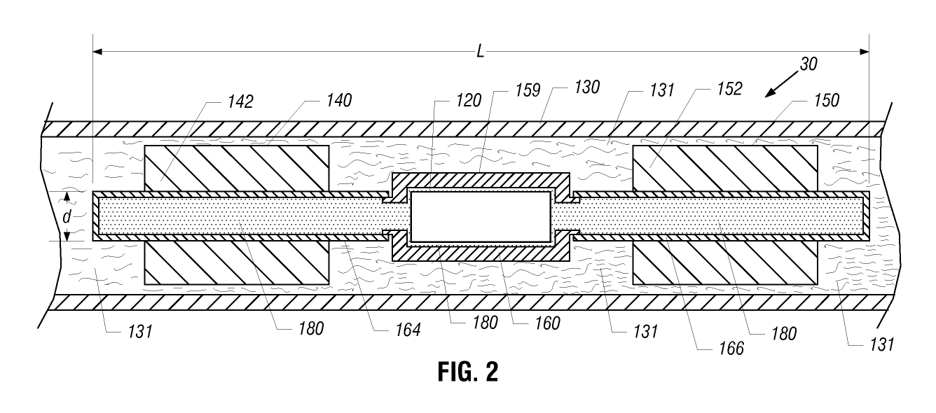

It has been discovered through simulation that the introduction of a fluid-filled enclosure that is locally disposed around the sensor and extends through the nearby spacers, attenuates the flow noise in a gel-filled streamer. Referring to FIG. 2, more specifically, in accordance with embodiments of the invention, an exemplary streamer 30 includes an outer skin 130 that defines an interior space that contains a gel 131, a filler material; seismic sensor elements 120 (one seismic sensor element 120 being depicted in FIG. 2); and spacers, such as exemplary spacers 140 and 150, which are located on either side of each sensor element 120. The spacers support the outer skin 130 protect the seismic sensor elements 120. Each spacer may be surrounded by a thin layer of the gel 131, as depicted in FIG. 2. Each seismic sensor element 120 contains a sensor holder that contains a seismic sensor (a multicomponent seismic sensor or a hydrophone, as examples).

As depicted in FIG. 2, the seismic element 120 is suspended in a material 180 (a fluid, such as kerosene, for example) inside an enclosure 159, which, in turn, is disposed in the interior space inside the outer skin 130. The material 180 has a shear stiffness less than the shear stiffness of the gel 131. In accordance with some embodiments of the invention, the enclosure 159 includes a main portion 160 that contains the seismic element 120 and lateral portions 164 and 166 that extend into corresponding passageways 142 and 152 of the spacers 140, 150, respectively.

In accordance with some embodiments of the invention, the lateral portions 164 and 166 are generally cylindrical, are formed from resilient materials and may resemble hoses. The presence of the material 180 in the gel-filled streamer creates a pocket to attenuate the flow noise that is otherwise present due to the use of gel as the filler material for the streamer 30.

As a more specific example, the total length L of the enclosure 159 may be about 60 centimeters (cm), in accordance with some embodiments of the invention. The length L depends on the stiffness of the gel 131. In this manner, the length L may be decreased and similar attenuation results may be achieved by decreasing the shear stiffness of the gel 131. The diameter d of the lateral 164, 166 is a function of the shear stiffness of the material 180. In this manner, the diameter d may be the lowest when the material 180 is a fluid. As an example, the diameter d may be between 4-15 millimeters (mm), in accordance with some embodiments of the invention.

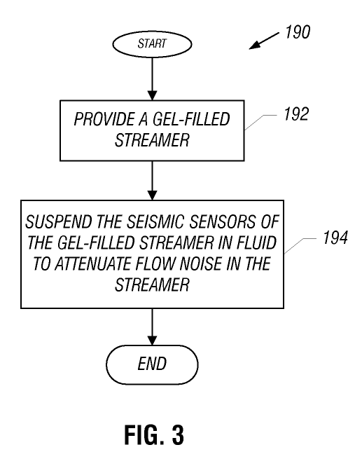

To summarize, FIG. 3 depicts an exemplary technique 190 in accordance with some embodiments of the invention. Pursuant to the technique 190, a cable is provided (block 192), which contains seismic sensors and a gel-based filler material. The technique 190 includes suspending (block 194) the seismic sensors in pockets of fluid in the cable attenuate flow noise in the cable.

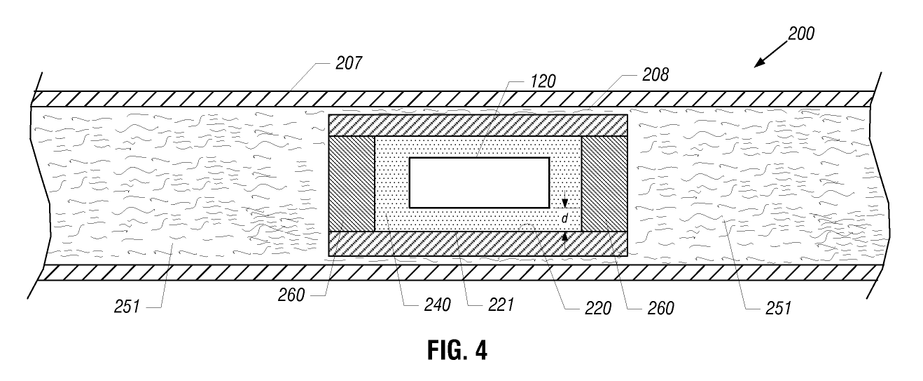

In accordance with other embodiments of the invention, a streamer may contain sensor elements that are suspended in gel inside the spacers. For example, referring to FIG. 4, a streamer 200 in accordance with some embodiments of the invention includes spacers (such as an exemplary spacer 208) and seismic sensor elements (such as exemplary seismic sensor element 120). The spacer 208 is located inside of and radially supports an outer skin 207 of the streamer 200. The streamer 200 is, in general, filled with a gel 251.

The spacer 208 includes an inner passageway 220 that is filled with a material 240. The material 240 may be a gel and may have a shear stiffness less than the gel 251, in accordance with some embodiments of the invention. As shown in FIG. 4, the seismic sensor element 120 is suspended inside the passageway 220 in the gel 240. In general, the seismic sensor element 120 is spaced apart by a radial distance d, such as 0.25 inches, from an inner wall 221 of the spacer 208, which defines the passageway 220. The passageway 220 may be plugged at both ends by plugs 260, in accordance with some embodiments of the invention. The spacer 208 may have radial inlet fill ports in accordance with other embodiments of the invention.

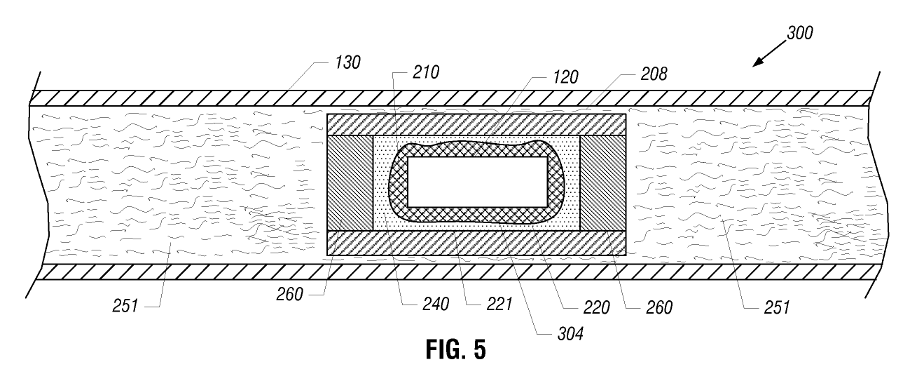

Referring to FIG. 5, as an example of another embodiment of the invention, a seismic streamer 300 has a similar design to the seismic streamer 200 of FIG. 4. However, unlike the streamer 200, in the streamer 300, the seismic sensor element 120 is enclosed by a protective sheath 304, which may be a flexible sheath, in accordance with some embodiments of the invention. Furthermore, in accordance with some embodiments of the invention, the sheath 304 contains a material 210 (a gel, for example) that has a shear stiffness that may be less than the shear stiffness of either of the materials 240 and 251.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. An apparatus comprising:
a cable;
a gel-based filler material disposed in the cable; and
seismic sensors suspended in pockets, each pocket containing a material that has a shear stiffness that is less than a shear stiffness of the gel-based filler material to attenuate a flow noise.

2. The apparatus of claim 1, further comprising:
spacers disposed in the cable.

3. The apparatus of claim 1, further comprising:
containers that contain the materials to form the pockets, wherein each of the containers extends at least partially through one of the spacers.

4. The apparatus of claim 1, wherein the seismic sensors comprise hydrophones and/or multi-component sensors.

5. The apparatus of claim 1, further comprising:
a survey vessel to tow the cable.

6. An apparatus comprising:
a cable containing a gel-based filler material;
a spacer having a passageway and being disposed in the cable;
an enclosure to contain a second material that has a shear stiffness that is less than a shear stiffness of the gel and being adapted to at least partially extend in the passageway; and
a seismic sensor to be suspended in the second material in the enclosure.

7. The apparatus of claim 6, further comprising:
a outer skin to define an interior space such that the spacer and the enclosure are disposed in the interior space and the spacer supports the outer skin.

8. The apparatus of claim 6, wherein the enclosure comprises a main portion to house the seismic sensor and a lateral portion to at least partially extend into the passageway of the spacer.

9. The apparatus of claim 6, wherein the apparatus comprises a streamer that includes the cable, spacer, gel, enclosure and seismic sensor, the apparatus further comprising:
a survey vessel to tow the streamer.

10. An apparatus comprising:
an outer cable covering defining an interior space;
a spacer to be located in the interior space to support the outer cable covering, the spacer comprising a passageway;
a gel located in the passageway; and
a seismic sensor to be suspended in the gel in the passageway.

11. The apparatus of claim 10, further comprising:
a sheath to be disposed in the passageway, the sheath to contain the sensor and the gel.

12. The apparatus of claim 11, further comprising:
another gel having a different shear stiffness than a shear stiffness of the first gel and being adapted to be disposed in the passageway outside of the sheath.

13. The apparatus of claim 10, further comprising:
a gel-based filler material for the cable.

14. The apparatus of claim 10, wherein the apparatus comprises a streamer cable that includes the outer cable cover, the spacer, the gel and the seismic sensor, the apparatus further comprising:
a survey vessel to tow the streamer.

15. A method comprising:
providing a cable that has a spacer and a gel-based filler material; and
suspending a seismic sensor in a gel in a passageway of the spacer.

16. The method of claim 15, further comprising:
disposing the seismic sensor in a sheath; and
suspending the seismic sensor in another gel inside the sheath.

17. The apparatus of claim 15, wherein said another gel has a shear stiffness that is less than a shear stiffness of the first gel.

18. A method comprising:
providing a cable containing seismic sensors and a gel-based filler material; and
attenuating a flow noise, comprising suspending the seismic sensors in pockets that contain materials that each have a shear stiffness that is less than a shear stiffness of the gel-based filler material.

19. The method of claim 18, wherein the cable comprises spacers, the method further comprising:
providing containers that contain the materials to form the pockets; and
extending each of the containers at least partially through one of the spacers.

20. The method of claim 18, further comprising:
towing the cable in connection with a seismic survey.
